(19) United States
(12) Patent Application Publication
(10) Pub. No.: US 2016/0335456 A1
(43) Pub. Date: Nov. 17, 2016

(54) VITAL DOCUMENT AND DIGITAL INFORMATION MANAGEMENT PROCESSES AND SYSTEM THAT SECURES AND RELEASES PERSONAL INFORMATION BEFORE AND AFTER A PERSON'S DEATH

(71) Applicant: Jose Felix Esparza, Yucaipa, CA (US)

(72) Inventor: Jose Felix Esparza, Yucaipa, CA (US)

(21) Appl. No.: 15/153,546

(22) Filed: May 12, 2016

Related U.S. Application Data
(60) Provisional application No. 62/162,386, filed on May 15, 2015.

(51) Int. Cl. G06F 21/62; G06Q 50/18; H04L 29/08

(52) U.S. Cl. CPC G06F 21/6263; H04L 67/306; G06Q 50/186

(57) ABSTRACT

A vital document and digital information management system is disclosed that secures and releases personal information before and after a person's death. The vital document and digital information management system is implemented as a web application that is customizable according to a user's liking. The web application volts and releases personal information before and after a person's death. The web application provides a social site that facilitates Internet communication and contact between family members. The web application generates a user profile for each family member using the social site.

### CLAIM OF BENEFIT TO PRIOR APPLICATION

This application claims benefit to U.S. Provisional Patent Application 62/162,386, entitled “VITAL DOCUMENT AND DIGITAL INFORMATION MANAGEMENT SYSTEM THAT SECURES AND RELEASES PERSONAL INFORMATION BEFORE AND AFTER A PERSON'S DEATH,” filed May 15, 2015. The U.S. Provisional Patent Application 62/162,386 is incorporated herein by reference.

### BACKGROUND

Embodiments of the invention described in this specification relate generally to digital information management processes and systems, and more particularly, to vital document and digital information management processes and systems that secure and release personal information of a person before and after the person's death.

A person loses or damages important document, pictures, videos, or legal information all the time. A person is not able to get information to family after his or her death. A person may need to have a message delivered at a later date in time.

Therefore, what is needed is a way for a person's important documents, pictures, videos, legal information, and other items of importance to be secured when not needed, but released when needed, especially in the event of a person's death and/or incapacitation, and a way to provide for preparation and customization of a universally accessible data resource, such as a website, by any person securing important documents, pictures, videos, legal information, and other items of importance so as to define access rights to various people who later may access the universally accessible data resource after the person's death.

### BRIEF DESCRIPTION

The disclosed invention includes a vital document and digital information management system and processes for securing personal information and vital documents of a person before a terminal event associated with the person and releasing the secured personal information and vital documents after the terminal event associated with the person. In some embodiments, the terminal event comprises one of death, confirmation of death, and confirmation of permanent incapacity and terminal illness.

Some embodiments include a vital document and digital information management process for securing personal information and vital documents of a person before a terminal event occurs in relation to the person and releasing the secured personal information and vital documents after the terminal event has occurred in relation the person. In some embodiments, the terminal event comprises one of death, confirmation of death, and confirmation of permanent incapacity and terminal illness.

Some embodiments include a vital document and digital information management system secures personal information and vital documents of a person before a terminal event occurs in relation to the person and releases the secured personal information and vital documents after the terminal event has occurred in relation to the person. In some embodiments, the terminal event comprises one of death, confirmation of death, and confirmation of permanent incapacity and terminal illness.

In some embodiments, the vital document and digital information management system is a cloud-based system comprising a set of cloud server computers and eternal testament software that runs on processors of the cloud server computers to provide an eternal testament cloud application service that is accessible to user computing devices operated by people who wish to create an eternal testament site of their own or view an eternal testament site of another person. In some embodiments, the cloud-based vital document and digital information management system further includes a set of public databases and a set of private databases that store eternal testament content and information for all eternal testament sites.

Some embodiments include an eternal testament setup process for preparing a universally accessible data resource to secure personal information of a living person and release the secured personal information after the person is deceased.

Some embodiments include an eternal testament release and view process for accessing a universally accessible data resource of a deceased person and viewing released personal information of the deceased person.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having thus described the invention in general terms, reference is now made to the accompanying drawings, which are not necessarily drawn to scale, and which show different views of different example embodiments, and wherein:

FIG. 1 conceptually illustrates a vital document and digital information management process in some embodiments for securing personal information and vital documents of a person before a terminal event occurs in relation to the person and releasing the secured personal information and vital documents after the terminal event has occurred in relation to the person.

FIG. 2 conceptually illustrates a vital document and digital information management system in some embodiments that secures personal information and vital documents of a person before a terminal event occurs in relation to the person and releases the secured personal information and vital documents after the terminal event has occurred in relation to the person.

FIG. 3 conceptually illustrates an eternal testament setup process in some embodiments for preparing a universally accessible data resource to secure personal information of a living person and release the secured personal information after the person is deceased.

FIG. 4 conceptually illustrates a process in some embodiments for accessing a universally accessible data resource of a deceased person and viewing released personal information of the deceased person.

FIG. 5 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted in any of several manners.

Embodiments of a vital document and digital information management system and processes for securing and releasing personal information and vital documents of a person before and after a terminal event, such as death or incapacitation, occurs in relation to the person are described. In describing the vital document and digital information management system and processes, a time-wise division of operations is detailed based on the terminal event. The time-wise division of operations includes (i) a first time period during which personal information and vital documents of the person are secured before the terminal event associated with the person and (ii) a second time period during which the secured personal information and vital documents are released after the terminal event associated with the person. In some embodiments, the terminal event comprises one of death, confirmation of death, and confirmation of permanent incapacity and terminal illness. However, the terminal event may be associated with a moment or instance of time, such as when a person dies or when a confirmation of death of the person is made, or may span a duration of time, such as the time from a person's reported death to the time of confirmation of the person's death.

As stated above, people often lose or damage important document, pictures, videos, or legal information. Unfortunately, when such vital data and/or personal information cannot be found or restored, people are unable to provide key life information to family and friends when needed most, specifically, upon death of a person. The range of vital data and personal information is broad, including at least vital documents, vital and/or personal information, family heirlooms, pictures, videos, audio recordings, etc. In addition, a person may need to have a message delivered at a later date in time, such as after death of the person or after the person becomes permanently incapacitated (e.g., by a catastrophic physical accident). All too often, traditional communication means are an afterthought because death or permanent incapacitation are often unexpected outcomes. This leaves a problem regarding the many documents, pictures, videos, audio clips, writings, and other digital data that are not easily managed by a person during life and that are nearly impossible to manage and/or distribute by others when the person dies or becomes permanently incapacitated. This is a problem that all people face.

Embodiments of the vital document and digital information management system and processes for securing and releasing personal information and vital documents of a person before and after a terminal event, such as death or incapacitation, occurs in relation to the person described in this specification solve such problems via a universally accessible resource in which a person may create an everlasting testament of themselves during their lifetime and provide access to the everlasting testament after their death.

In this specification, the vital document and digital information management process, the eternal testament setup process, the process for accessing a universally accessible data resource of a deceased person and viewing released personal information of the deceased person, and the vital document and digital information management system are described at a level of detail that, in many instances, goes beyond the corresponding descriptions in the related provisional application, which this application claims benefit to, namely, U.S. Provisional Patent Application 62/162,386, entitled “VITAL DOCUMENT AND DIGITAL INFORMATION MANAGEMENT SYSTEM THAT SECURES AND RELEASES PERSONAL INFORMATION BEFORE AND AFTER A PERSON'S DEATH,” filed May 15, 2015. However, a person skilled in the art relevant to the present invention would appreciate that the further details and descriptions provided in this specification are directly related to the descriptions in the specification for U.S. Provisional Patent Application 62/162,386, wherein a vital document and digital information management system and related processes were described in such a manner as to relate elements and aspects of the vital document and digital information management system to the novel aspects of the vital document and digital information management system and processes of the present invention. Thus, in this disclosure, the novel aspects of the vital document and digital information management system and the related processes are exemplified in and described by reference to the drawings that accompany this disclosure. In the present descriptions, as in the descriptions of the novel aspects of the inventive embodiments in the specification for U.S. Provisional Patent Application 62/162,386, the vital document and digital information management process and the vital document and digital information management system include a temporal shift that depends upon a subject person's living status. The temporal shift may be days, weeks, months, or years, or another time difference. The transition between one time period and another time period is event driven (e.g., death of a person triggers a shift), but only shifts fully upon a confirmation of death. In describing such an event-driven shift, therefore, one should understand that much terminology is used generally, such as the terms and phrases “waiting,” “continues until,” “waits for,” etc.

In some embodiments, the vital document and digital information management system is implemented as a website portal that architecturally includes several layers of interactive website resources. The interactive website resources include at least a website user interface (UI) at a presentation layer, a web application that runs in a background layer, and a set of content creation tools that are accessible from the website UI and function within the web application in the background layer. The website UI and the web application are customizable according to a person's liking. In some embodiments, the website volts and releases personal information before and after a person's death. Thus, by providing an everlasting testament web application through a web site, the system ensures a personal finger print of the person can be left behind for his or her loved ones.

Some embodiments of the vital document and digital information management system described in this specification differ from and improve upon currently existing vital document storage systems. In particular, some embodiments of the vital document and digital information management system differ by covering all areas of data storage that other sites do not cover. For example, the vital document and digital information management system covers all areas such as personal pictures, thoughts, videos, scanned documents such as dairies, letters, awards, certificates, legal documents such as marriage licenses, wills, living wills, bank information, codes to safes or bank accounts, etc. In addition, the vital document and digital information management system of some embodiments includes a website portal that keeps track of a person's childhood, such as first words, first day at school, special dates in a person's life, whatever a person wants to share with their loved ones. The web site may also keep track of other family members that have be assigned as recipients of a person's personal information. The website may also give a person an opportunity to create a eulogy presentation by choosing, for example, special pictures, videos, or songs of their choosing. In some embodiments, such a eulogy presentation may be released to the designated recipients upon death of the person. In some embodiments, the vital document and digital information management system includes expansive storage space in which there may be no limit to the amount of information a person can upload and store as part of their vital document corpus.

In addition, these embodiments improve upon the currently existing options because the website portal can be presented to a person in any of several different interface layouts and designs which provide access to one or more discrete functional units of the vital document and digital information management system. In this way, others can provide services from the vital document and digital information management system on individual terms.

In this specification, there are descriptions of processes and methods that are performed by software running on a computing device or mobile device (e.g., smartphone, tablet, etc.) of a user and/or a server computing device that is accessible from computing devices and/or mobile devices of users over the Internet in order to interact with a cloud-based eternal testament web application service and one or more associated cloud-network databases that include all eternal testament site content and information from all registered users who have created an eternal testament site. However, it should be noted that for the purposes of the embodiments described in this specification, the word “method” is used interchangeably with the word “process”. Methods are described, therefore, by reference to example processes that conceptually illustrate process steps for securing personal information and vital documents of a person before a terminal event occurs in relation to the person and releasing the secured personal information and vital documents after the terminal event has occurred in relation to the person.

Several more detailed embodiments are described below. Section I describes a process for securing personal information and vital documents of a person before a terminal event occurs in relation to the person and releasing the secured personal information and vital documents after the terminal event has occurred in relation to the person. Next, Section II describes a vital document and digital information management system that secures personal information and vital documents of a person before a terminal event occurs in relation to the person and releases the secured personal information and vital documents after the terminal event has occurred in relation to the person. Following the vital document and digital information management system description is Section III, which includes descriptions of an eternal testament setup process for preparing a universally accessible data resource to secure personal information of a living person and release the secured personal information after the person is deceased. Next, Section IV includes a description of a process for accessing a universally accessible data resource of a deceased person and viewing released personal information of the deceased person. Lastly, Section V describes an electronic system that implements some embodiments of the invention.

### I. Vital Document and Digital Information Management Process

Some embodiments include a vital document and digital information management process for securing personal information and vital documents of a person before a terminal event occurs in relation to the person and releasing the secured personal information and vital documents after the terminal event has occurred in relation to the person. In some embodiments, the terminal event comprises one of death, confirmation of death, and confirmation of permanent incapacity and terminal illness.

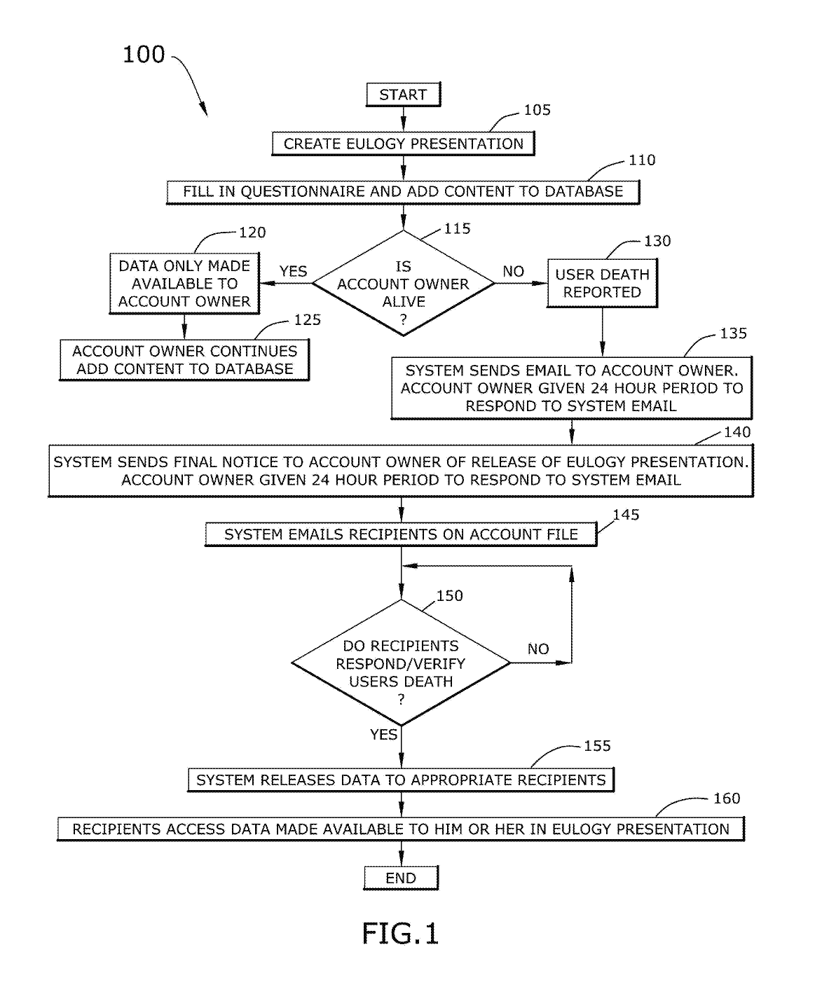

By way of example, FIG. 1 conceptually illustrates a vital document and digital information management process 100 for securing personal information and vital documents of a person before a terminal event associated with the person and releasing the secured personal information and vital documents after the terminal event associated with the person. The vital document and digital information management process 100 may be performed when a browser application running on a computing device connects to an eternal testament website hosted by a cloud-based web application server that provides an eternal testament service by way of an eternal testament web application.

In some embodiments, the vital document and digital information management process 100 starts after a living person associated with a registered account on the eternal testament website wants to create a personal testament. For example, the living person may be creating a personal testament of their own life, or the living person may be another person on behalf of a personal testament for another person. Thus, when the person accesses the eternal testament service and logs into the eternal testament website, the vital document and digital information management process 100 of some embodiments receives personal information that creates (at 105) a eulogy presentation. Next, the vital document and digital information management process 100 receives questionnaire information and content (at 110) in connection with the person filling in a questionnaire and providing content items to add to a content database for the personal testament being created. For example, the person may provide basic biographical information and media items, such as a profile picture or video, which can be used in one or more sections of the personal testament. Alternatively, a representative of a deceased person may be accessing the eternal testament website in order to provide information about the deceased person.

In some embodiments, the vital document and digital information management process 100 determines (at 115) whether the account owner is alive. For example, if the person accessing the eternal testament website is a representative of the deceased person, then the account owner may be the deceased person. When the account holder is alive, the vital document and digital information management process 100 makes the data only available to the account owner (at 120). Next, the vital document and digital information management process 100 enables the account owner to continue to add content to the database (at 125).

On the other hand, when the account holder is not alive, the vital document and digital information management process 100 includes a step in which the user death is reported (at 130). In this circumstance, the vital document and digital information management process 100 sends email to the account holder (at 135) and the account holder is given a brief period of time to respond to the email. For example, the account holder may be given 24 hours to respond to the email message. That way, if the reported death is inaccurate, the account holder can correct the system before providing accessible to the personal testament to others. In some embodiments, the vital document and digital information management process 100 sends (at 140) a final notice to the account owner regarding the release of eulogy presentation, providing the account owner a period of time to respond (e.g., 24 hours).

When no response from the account holder is received within the time period, the vital document and digital information management process 100 then emails (at 145) recipients that are listed in connection with the account file. In some embodiments, the vital document and digital information management process 100 determines (at 150) whether recipients respond to the email in verification of the person's death. When none of the recipients respond to the email, the vital document and digital information management process 100 cycles back to wait for response from the recipients.

On the other hand, when one or more of the recipients does respond to verify the person's death, then the vital document and digital information management process 100 releases (at 155) the personal testament data to appropriate recipients. For example, a list of recipients may be granted general access to the personal testament, while a select few recipients in the list may be granted full access to everything in the personal testament. Finally, the vital document and digital information management process 100 allows the recipients (at 160) to access the data made available in the eulogy presentation. Then the vital document and digital information management process 100 ends.

“a”

### II. Vital Document and Digital Information Management System

In some embodiments, a vital document and digital information management system secures personal information and vital documents of a person before a terminal event occurs in relation to the person and releases the secured personal information and vital documents after the terminal event has occurred in relation to the person. In some embodiments, the terminal event comprises one of death, confirmation of death, and confirmation of permanent incapacity and terminal illness.

For example, when the terminal event is death, the vital document and digital information management system secures personal information and vital documents of a living person before the person dies and, therefore, would release the secured personal information and vital documents to designated other people when the person is deceased (e.g., after death occurs or after death is established and confirmed).

In some embodiments, the vital document and digital information management system is a cloud-based system comprising a set of cloud server computers and eternal testament software that runs on processors of the cloud server computers to provide an eternal testament cloud application service that is accessible to user computing devices operated by people who wish to create an eternal testament site of their own or view an eternal testament site of another person. In some embodiments, the cloud-based vital document and digital information management system further includes a set of public databases and a set of private databases that store eternal testament content and information for all eternal testament sites,

In some embodiments, the vital document and digital information management system is implemented as a website portal that architecturally includes several layers of interactive website resources. The interactive website resources include at least a website user interface (UI) at a presentation layer, a web application that runs in a background layer, and a set of content creation tools that are accessible from the website UI and function within the web application in the background layer. The website UI and the web application are customizable according to a person's liking. In some embodiments, the website volts and releases personal information before and after a person's death. Thus, by providing an everlasting testament web application through a web site, the system ensures a personal finger print of the person can be left behind for his or her loved ones.

In some embodiments, the vital document and digital information management system provides a set of content creation tools on the website portal which allow a person to record a message or video in an advance of an event, a calendar date, or a possible detrimental outcome. For example, before deployment overseas in a combat area, a person could record a message or video for loved ones before being deployed. The person can store the message or video in the vital document and digital information management system, and specify people who would be able to receive the message. The person could also specify a date to release the message (e.g., one week after deployment) or another time (e.g., upon confirmation of death). A person will also be able to assign a number of recipients (e.g., family members, lawyers, etc.) who can be contacted and given sensitive information such as legal documents in the event of the users death.

Also, a person can access their vital documents and digital information management system user account through the website at any time or any place via an Internet system login portal. The information stored for the person in the vital document and digital information management system will be information that the person provides over the Internet (e.g., by using data file uploading tools provided through the website portal). For example, a person may receive a confirmation of eligibility for certain economic account benefits, which upon death, would include partial distributions to one or more relatives of the person. By using the vital document and digital information management system, the person could upload a digital file of the eligibility document and would never have to worry about the eligibility document being lost or damaged. Similarly, a person using the vital document and digital information management system never has to worry about damaging or losing important pictures, videos, journals, documents, legal documents, etc., which are uploaded and stored in the vital document and digital information management system.

In some embodiments, the implementation of the website portal of the vital document and digital information management system may be comprised of the following interactive website resources. This list of possible constituent interactive website resources is intended to be exemplary only and it is not intended that this list be used to limit the vital document and digital information management system and/or the implementation of the website portal of the present application to just these interactive website resources. Persons having ordinary skill in the art relevant to the present disclosure may understand there to be equivalent interactive website resources that may be substituted within the present disclosure without changing the essential function or operation of the vital document and digital information management system and/or the implementation of the website portal.

1. Icon Inbox

2. Picture icon

3. Time locked content icon

4. Legal documents icon

5. Eulogy presentation icon

6. Recipient Name icon

7. “Diary” icon

8. “My First . . . ” icon

9. “Achievements/Life Goals” icon

10. Scanned materials icon

11. Videos icon

12. Add New Icon

13. Add Recipient

14. Upload to Inbox

15. Update profile

16. Contact Us

17. Terms & Conditions

18. Report a Passing

19. New

20. About Us

21. Home Page

22. Q & A

23. Tutorial

24. Search tool

25. Move to existing folder

26. View item

27. Delete

28. Create a new folder

29. Open

30. Edit

31. Add to eulogy collection

32. Remove item

33. Title/Date

34. Description

35. Public

36. For My Eyes Only

37. Assign Recipient(s)

38. Family Tree Icon

40. Date and time of release

41. Release upon my death

42. Edit Tool #3

43. Edit Tool #4

44. Facial recognition software.

The various interactive website resources of the implemented website portal of the vital document and digital information management system of the present disclosure may be related in the following exemplary fashion. It is not intended to limit the scope or nature of the relationships between the various interactive website resources and the following examples are presented as illustrative examples only.

1. Inbox Icon: When a user clicks on this icon he or she will be able to open a new window that will display the content he or she has uploaded to the site. When the user moves the curser over the content the user will be prompted to choose a command to (25) move to existing folder, (26) view item, (27) delete, (28) create new folder. The Inbox icon will hold all new content that has been uploaded to the site. Items will remain in the Inbox until the user chooses a folder of his or her choosing.

2. Picture icon: When a user clicks on this icon he or she will be able to view existing picture albums the user has uploaded onto the site. If the user places the cursor over the album the user will be prompted to (29) open, (30) edit (31) add to eulogy collection. In the Picture icon the user will be able to store pictures that have been uploaded and create albums with pictures and descriptions of the content uploaded.

3. Time locked content icon: When a user clicks on this icon he or she will be able to open a window to items the user has marked as time and date sensitive. When the user places the cursor over the item the user will be prompted to (26) view item, (41) edit tool #3, (28) create new folder. In the Time locked content icon the user will be able to store information that he or she wants to share a later designated date and time. The content can vary from special birthday messages, congratulations, anniversary messages, final wishes, etc. The user will have to re-enter his or her password before being able to access this folder.

4. Legal documents icon: When a user clicks on this icon he or she will be able to open a new window that will display a document folder. When the user places the cursor over the document folder the user will be prompted to (26) view item, (42) edit tool #4. Before the user can access accuses this information the user will have to enter his or her password. The user will be able to store important legal documents such as will, living will, trust, DD214, bank information, etc. any items a user considers to have a legal value to it. The content in the legal document folders will only be released upon the presenting of a death certificate to Everlasting Testament and associates or if the user specifies otherwise.

5. Eulogy presentation icon: When a user clicks on this icon he or she will be able to open a new window that will display a folder with item the user has chosen to be placed in his or her eulogy presentation. When the user places the cursor over the folder the user will be prompted to (26) view item, (32) remove item, (30) edit. In the Eulogy presentation icon the folder will contain all the content that a user has chosen to be part of his or her Eulogy. Of all the information that is uploaded onto the site the user will have the option of adding it to their eulogy presentation. The user will also have the option of choosing the songs that he or she would like to be played from our list of songs that are appropriate for the occasion or the user can pick songs of their own liking. This presentation will be made available to the family only after 80% of the recipients on the account have reported the account holder as deceased. No other documents will be released until a death certificate is presented or we are instructed otherwise.

6. Recipient Name icon: When a user clicks on this icon he or she will be able to open a new window that will display the items that have been assigned to the recipient. When the user places the cursor over the item the user will be prompted to (26) view item, (32) remove item, (30) edit. In the Recipient icon folder the user can manage all the information that has been assigned to the recipient. The information that is assigned to a recipient can only be viewed by that particular recipient and no other person.

7. Diary icon: When a user clicks on this icon he or she will be able to open a new window that will display folders that have been create by the user. When the user places the cursor over the icon the user will be prompted to (26) view item, (30) edit, (28) create new folder. In the Dairy icon the user will have the opportunity to write messages that can be assigned to a recipient or made public for all recipients to. Furthermore, the user can add these messages to their eulogy presentation folder.

8. “My First . . . ” icon: When a user clicks on this icon he or she will be able to open a new window that will display items that have been assigned to this folder. When the user places the cursor over the item the user will be prompted to (26) view item, (30) edit, (28) create new folder (31) add to eulogy collection. In the “My first . . . ” icon the user will be able to document all their firsts of life such as first words, first day of school, etc.

9. Achievements & Life Goals icon: When a user clicks on this icon he or she will be able to open a new window that will display items that have been assigned to this folder. When the user places the cursor over the item the user will be prompted to (26) view item, (30) edit, (28) create new folder, (31) add to eulogy collection. In the Achievements & Life Goals icon the user will be able to leave themselves videos or messages of goals they want to achieve before they set out to accomplish them. For example, goals set before leaving for college these goals will be locked until a later time in the future that the user choses. Once the time limit is reached the user can revisit the goals to see if they have accomplished the goals or refresh their mind of what their goals were. The user can also keep track of goals and achievements he or she have accomplished.

10. Scanned materials icon: When a user clicks on this icon he or she will be able to open a new window that will display items that have been assigned to this folder. When the user places the cursor over the item the user will be prompted to (26) view item, (30) edit, (28) create new folder, (31) add to eulogy collection. In the Scanned materials icon the user will be able to keep anything he or she wished to scan and place on their site thing item can include but are not limited to person journals, new paper articles, family recipes, etc.

11. Videos icon: When a user clicks on this icon he or she will be able to open a new window that will display items that have been assigned to this folder. When the user places the cursor over the item the user will be prompted to (26) view item, (30) edit, (28) create new folder, (31) add to eulogy collection. In the videos icon the user can store videos of special events in his or her life or anything or his or her liking the user is only limited to his or her imagination.

12. Add new icon: When a user clicks on this toolbar he or she will be able to open a new window that will give the user the option to create their very own icon. When the user places the cursor over the item the user will be prompted to (26) view item, (30) edit, (28) create new folder. With this option the user will be able to create new icons of his or her choosing. The user will have the opportunity to name the icon and the options that will be needed for the icon.

13. Add recipient: When a user clicks on this toolbar he or she will be able to open a new window that will give the user the option to add new recipient to their account which will create a new icon for the recipient. In this option the user will be able to add new recipient to the account who will in turn be given the authority to report the account holder as decided and contribute their share of the percentage that is needed to release the eulogy presentation.

14. Upload to inbox: When a user clicks on this toolbar he or she will be able to open a new window that will give the user the option to upload data from their personal unit onto our site. The Upload option will give the user the opportunity to access his or her file and upload them to their site. The Upload option will work similar to attaching an item to an e-mail. The content can later be accessed on the Inbox icon.

15. Update profile: When a user clicks on this toolbar he or she will be able to open a new window that will give the user the option to update account information and make necessary changes.

16. Contact Us: When a user clicks on this toolbar he or she will be able to open a new window that will give the user the option to contact us via e-mail or phone.

17. Terms and Conditions: When a user clicks on this toolbar he or she will be able to open a new window that will give the user the option to view the terms and conditions that have been agreed upon in order to use or site.

18. Report a passing: When a user clicks on this toolbar he or she will be able to open a new window that will give the user the option to contact us and let us know if the person has passed. Once 80% of the recipients have reported the passing of a person the eulogy presentation will be released.

19. New: The word “New” will be displayed over icons that contain new content that has not yet been seen.

20. About Us: When a user clicks on this toolbar he or she will be able to open a new window that will give the user background information about our company and associates.

21. Home Page: When a user clicks on this toolbar he or she will be able return back to the home page where all the icons are displayed.

22. Q & A: When a user clicks on this toolbar he or she will be able to open a new window that will give the user the option to view command questions that are asked about our service.

23. Tutorial: When a user clicks on this toolbar he or she will be able to open a new window that will give the user the option to pick from a variety different tutorial videos or instructions on how to use and navigate on our site.

24. Search: When a user clicks on this toolbar he or she will be able to search for specific items by name or date or order of uploading.

25. Move to Existing folder: This option will appear when the curser is placed over New content box located in the (1) Inbox. This will bring up a new window that will let the user choose the folder that the item will be sent to.

26. View item: This option will open any item the user chooses to view.

27. Delete: This option will give the user the option to remove an item from the site. Before the item is remover the user will be prompted to double check to delete item before it is removed from the site.

28. Create new folder: when the user clicks on this option the user will be able to create a new folder that will remain in the section the user has created it in (e.g., if chosen in videos, it will only exist in videos unless the user moves item to a different icon folder).

29. Open: to open a project related to an eternal testament website.

30. Edit: With this option a person will be able to edit any folder or item that he or she would like. The user will be able to (33) Title/date, give a short (34) Description, make item (35) public, or make an item private (36) for my eyes only, or (37) assign Recipient. (25) Move to existing folder. (27) Delete.

31. Add to eulogy collection: This option places items chosen to be added to the eulogy presentation folder that the user has been creating from the very start of the site.

32. Remove item: this option will remove an item from a folder and sent it back to the Inbox, this option does not delete item off the site.

33. Title/date: this option will appear above each item or folder the user can name the item but the date will automatically be issued by or system upon uploading the item to the site.

34. Description: This option encourages users to place a short description of the item or folder to make navigations purposes easier.

35. Public: This option will give the user the authority to make the item or folder visible to all recipients that visit the site.

36. For My Eyes Only: This option will make items or folders only visible to the account holder.

37. Assign Recipient(s): This option will let the account holder grant access to an item or folder to a recipient(s) of his or her choosing.

38. Family Tree Icon: When a user clicks on this icon he or she will be able to open a window to items the user has marked as time and date sensitive. When the user places the cursor over the item the user will be prompted to (26) view item, (30) edit, (28) create new folder.

39. The user will also be able to link his or her account to other accounts through the family tree. When the user clicks on the picture of the person on the family tree the person will then be directed to the other person if ether one is a recipient in either of the accounts. The Family Tree icon will link account holder to their recipient and will be able to view any items that were made public on the recipient's accounts. The recipient will have the same option if he or she has an account with everlasting testament. On the family tree folder the user will also be able to keep family history such as family recipes, medical conditions that are genetically dominate to the family or any other family related content.

40. Date and time of release: With this option a user will be able to specify the date and time the he or she wishes to have information released.

41. Release upon my death: With this option a user will be able to have information secured in our vault until a designated recipient contacts us and provides a death certificate. Then and only then will information be released.

42. Edit Tool #3: This editing tool will be assigned to the #3 icon. It will give the user the option to edit information specific to the information contained in the folder.

43. Edit Tool #4: This editing tool will be assigned to the #4 icon. It will give the user the option to edit information specific to the information contained in the folder.

44. Create account for my child: When a user clicks on this toolbar he or she will be able to open a new window that will give the user the option to create an account for his or her child. The user will start an account for their child that the user will be able to update and maintain similar to that of their own. The user will have the option to choose an age he or she is appropriate for the child to take over the account or he or she can share editing powers until the child reaches the age of thirteen at which point the child can manage his or her own account.

45. Family history: When a user clicks on this toolbar he or she will be able to open a new window that will give the user the option to view or add to the family history that has been posted on the family Tree.

46. Note: facial recognition software will be used to randomly check if the person using the site is the account holder. If our software does not recognize the user it will automatically sign them off the account.

47. A cropping tool will be available to the user so that he or she can customize their icon. A generic form of icon will exist when the user first enters our site so the user will have the option to change the icon or keep it as is.

48. The user will be able to customize picture albums or use one of our templates that will be themed for different occasions such as holidays, birthdays, sports, etc.

49. After a person has been reported as decided all content that is in the inbox and was not assigned to a folder will be made available to the recipients associated to the account.

50. In order to help protect our user's sensitive information legal documents will be release only after the family has presented a certification of death to one of our attorney's and the certificate has been authenticated.

The vital document and digital information management system of the present disclosure generally works by the specified operations of a person using the system. In particular, operations related to one or more of the functions 23-37 listed above.

To make the vital document and digital information management system of the present disclosure, a person would have to create a web site that functions and operates in the manner described in this disclosure. The person can use one or more of several different coding and programming languages to create the web site and its underlying functional components. The person would also have to develop code to manage all the tasks that our site offers.

A person skilled in the art would understand that the names of the options and icons described in this specification are only exemplary names and descriptions that can be changed without changing the underlying functions and/or operations of the invention disclosed in this specification. Additionally, the look and feel of any user interfaces described in this disclosure are purely exemplary, and as a person skilled in the art would understand, could be substituted by other interfaces.

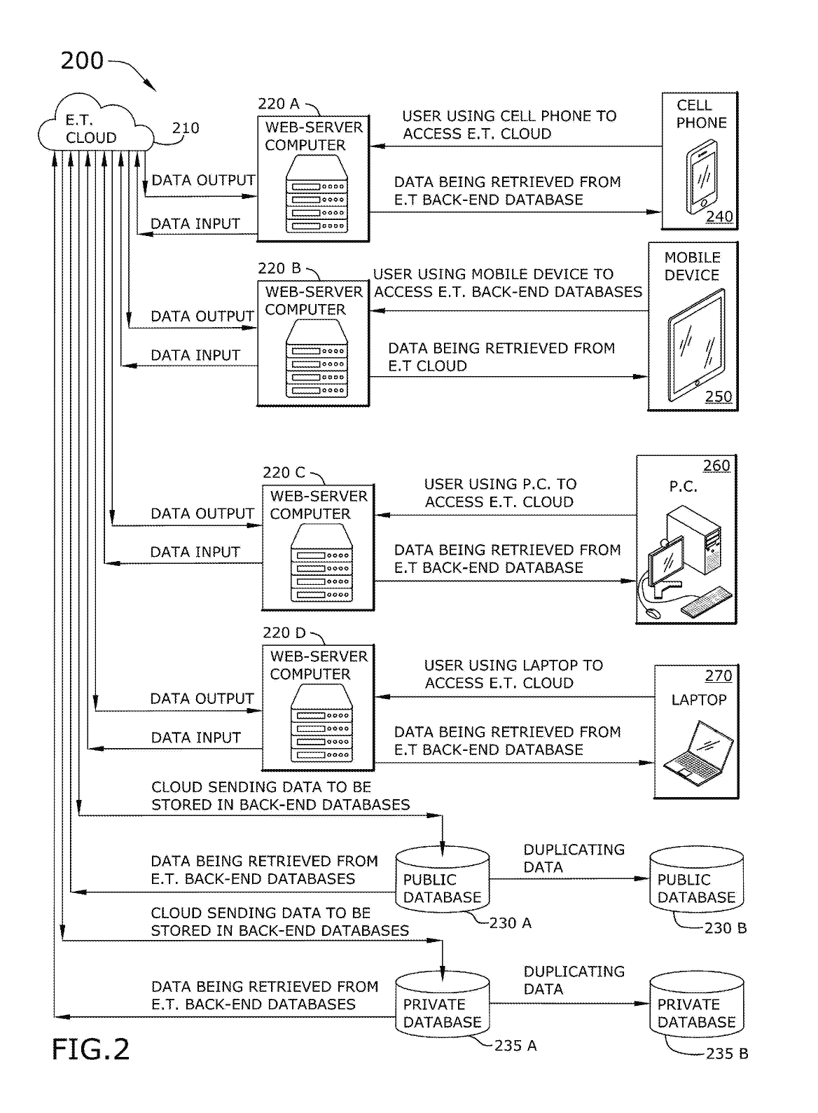

By way of example, FIG. 2 conceptually illustrates a vital document and digital information management system 200 that secures personal information and vital documents of a person before a terminal event occurs in relation to the person and releases the secured personal information and vital documents after the terminal event has occurred in relation to the person. As shown in this figure, the vital document and digital information management system 200 is a cloud-based system that hosts an eternal testament cloud application service 210 by way of a set of cloud server computers 220A-D that are accessible to a set of user computing device 240-270. In this figure, the set of user computing devices comprises a cell phone 240 (such as a smartphone), a mobile device 250 (such as a tablet computing device), a traditional personal computer 260 (e.g., “P.C.”), and a laptop computer 270. In addition, the cloud-based vital document and digital information management system 200 includes a set of databases, including a pair of public databases 230A-B (i.e., a public database 230A and a duplicated public database 230B) and a pair of private databases 235A-B (i.e., a private database 235A and a duplicated private database 235B).

In some embodiments, eternal testament software runs on processors of the cloud server computers 220A-D to provide a website presentation layer through which the user computing devices 240-270 can access the eternal testament cloud application service 210. In addition, the eternal testament software may include the content creation tools that allow the people operating the user computing devices 240-270 to create eternal testament sites and/or view eternal testament sites of other people. In some embodiments, the set of public databases 230A-B and the set of private databases 235A-B store eternal testament content and information for all eternal testament sites.

### III. Eternal Testament Setup Process

In some embodiments, an eternal testament setup process for preparing a universally accessible data resource that enables a living person to secure personal information in an eternal testament site commemorating important items, events, and other things in the person's life, which are released after the occurrence of a terminal event in relation to the person.

To use the vital document and digital information management system of the present disclosure, a person may register for an account to create an eternal testament site. The person may use the eternal testament setup process to create an account and add content to the eternal testament site. In some cases, the person will perform the eternal testament setup process once, adding all content, information, and other items in the eternal testament site. In other cases, the person may repeatedly use the eternal testament setup process to continually add new content to the eternal testament site.

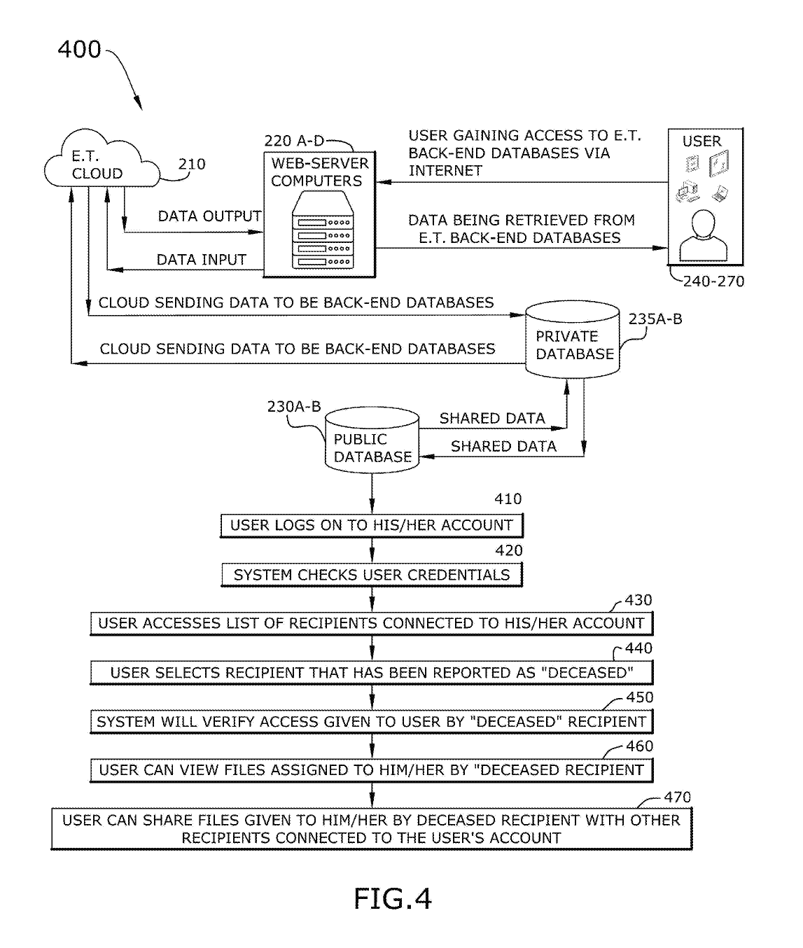

Alternatively, a person viewing content related to another person's eternal testament site would access the system via the Internet when a person's eulogy presentation is ready for viewing. A detailed description of a process for viewing the content is described below by reference to FIG. 4.

Additionally, some embodiments of the vital document and digital information management system can be adapted so that a person can use the system through one or more programs or apps on a computing device, such as a smart phone, or any other kind of computing device that is capable of accessing the Internet.

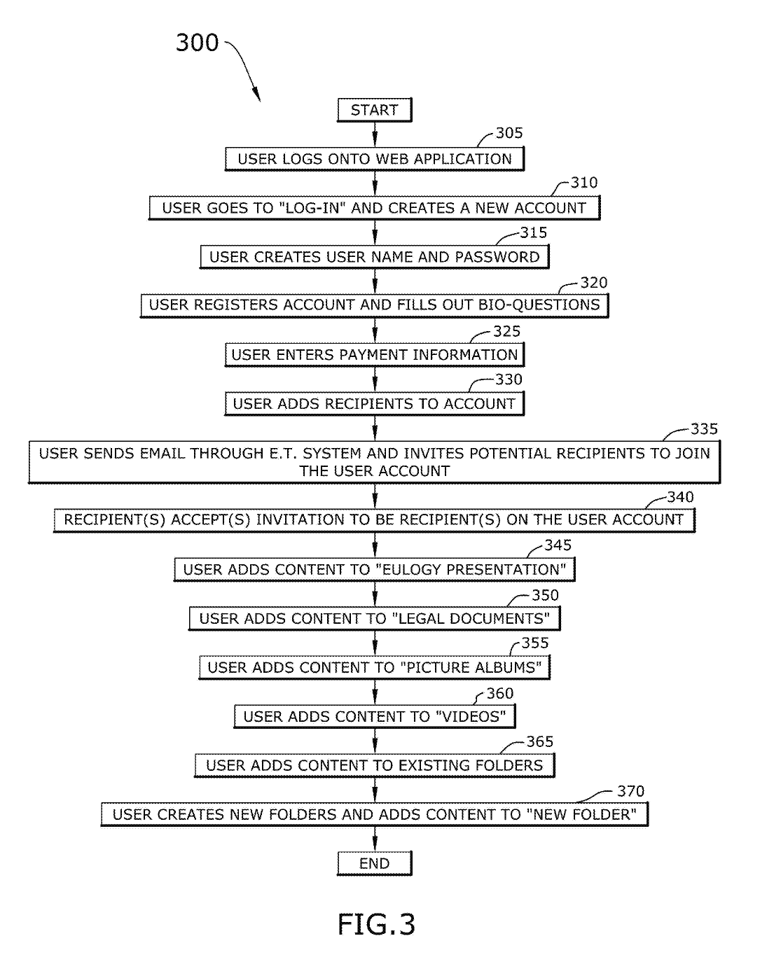

By way of example, FIG. 3 conceptually illustrates an eternal testament setup process 300 for preparing a universally accessible data resource that enables a living person to secure personal information in an eternal testament site commemorating important items, events, and other things in the person's life, which are released after the occurrence of a terminal event in relation to the person. The eternal testament setup process 300 may be implemented as a web application that presents on a person's computing device when the computing device of the person is running a browser software application that accesses the eternal testament cloud application service over the Internet.

As shown in this figure, the eternal testament setup process 300 includes a step in which the person (or rather, “the user”) logs onto the web application (at 305). In doing so, the user goes to “log-in” and creates (at 310) a new account. Next, the user creates a username and password (at 315) for login credentials. The user then registers the account and fills out biographical questions (at 320), and then enters payment information (at 325) if needed or required by a hosting or sponsoring service. In some embodiments, steps 310-325 are optional steps and only performed when the user is creating a new account, but skipped if the user already has an existing account.

In some embodiments, the eternal testament setup process 300 includes a step in which the user adds recipients to the account (at 330). The recipients are those people who the user wishes to allow access after dying. Next, the user sends (at 335) email through the eternal testament system and invites potential recipients to join the user account. Recipients then accept the invitation (at 340) to be recipients on the user's account. However, not all recipients need respond or wish to be added, and those which do not respond are not added.

In some embodiments, the eternal testament setup process 300 includes content-adding steps for the user to add, change, update, remove, etc., content related to his or her eternal testament site. Thus, the user adds content to his or her eulogy presentation (at 345), and adds content to a legal documents section (at 350), if any such content available to be added. Next, the user adds content to the picture albums (at 355). For example, the user may add new images, add updated images, changes images, remove images, or may add textual meta-data and/or descriptive information about various images in the picture albums section of the eternal testament site. In similar fashion, the user adds content to the videos section (at 360), providing updated video clips, new video clips, removing video clips, and/or providing textual information about the video clips or cross references to other sections (such as the picture albums or eulogy presentation, etc.). Next, the user adds all other content to the existing folders (at 365) as needed. Finally (at 370), the user may create new folders and/or may add content to a new folder, etc. Then the eternal testament setup process 300 ends.

### IV. Eternal Testament Release and View Process

Some embodiments include an eternal testament release and view process for accessing a universally accessible data resource of a deceased person and viewing released personal information of the deceased person.

By way of example, FIG. 4 conceptually illustrates an eternal testament release and view process 400 for accessing a universally accessible data resource of a deceased person and viewing released personal information of the deceased person. The eternal testament release and view process 400 may be implemented as a web application that presents on a person's computing device when the computing device of the person is running a browser software application that accesses the eternal testament cloud application service over the Internet in order to view another person's eternal testament site.

As shown in this figure, the eternal testament release and view process 400 relates to the vital document and digital information management system 200 described above by reference to FIG. 2. Thus, the user may be a person who uses a computing device, such as cell phone 240, tablet mobile device 250, desktop computer 260, or laptop computer 270 to connect over the Internet to a web-server computer 220A, 220B, 220C, or 220D, and perform one or more operations through the eternal testament cloud application service 210 to view and/or release eternal testament site content or information. Changes and/or updates are all saved to the private databases 235A and 235B for private updates or changes, as well as the public databases 230A and 230B, for public content updates or changes.

In some embodiments, the user logs on to his/her account (at 410). Next, the system checks (at 420) the user login credentials. Once logged into the eternal testament cloud application service 210, the user accesses (at 430) a list of recipients connected to his/her account. Then the user selects a recipient that has been reported as “deceased” (at 440). The system verifies (at 450) that the user has proper authorization and access given by the “deceased” recipient to actually make this confirmation. If there is proper authority, then the user can view files assigned to him/her by the “deceased” recipient (at 460). Finally, the user can share files (at 470) given to him/her by the “deceased” recipient with other recipients connected to the user's account. Then the eternal testament release and view process 400 ends.

Therefore, when it comes to ensuring that a person's important documents, pictures, videos, legal information, and other items of importance will be secured and released to important friends and family, the vital document and digital information management system and processes for securing personal information and vital documents of a person before a terminal event associated with the person and releasing the secured personal information and vital documents after the terminal event associated with the person described above by reference to FIGS. 1-4, provide the functional ability for building and maintaining an eternal testament site (such as a web site) that is a universally accessible data resource by any person securing important documents, pictures, videos, legal information, and other items of importance so as to define access rights to various people who later may access the universally accessible data resource after the person's death, and which can accommodate content growth and changes throughout a person's lifetime, that can be configured to provide general and specific user access after the person dies or becomes permanently incapacitated. While the examples and descriptions above focus largely on implementations of cloud-network web application services that provide the data communication and content storage and retrieval network framework, a person skilled in the relevant art would appreciate that such implementations are only exemplary, and not to be construed as the only implementations of the system and processes of the inventive embodiments described herein.

### V. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

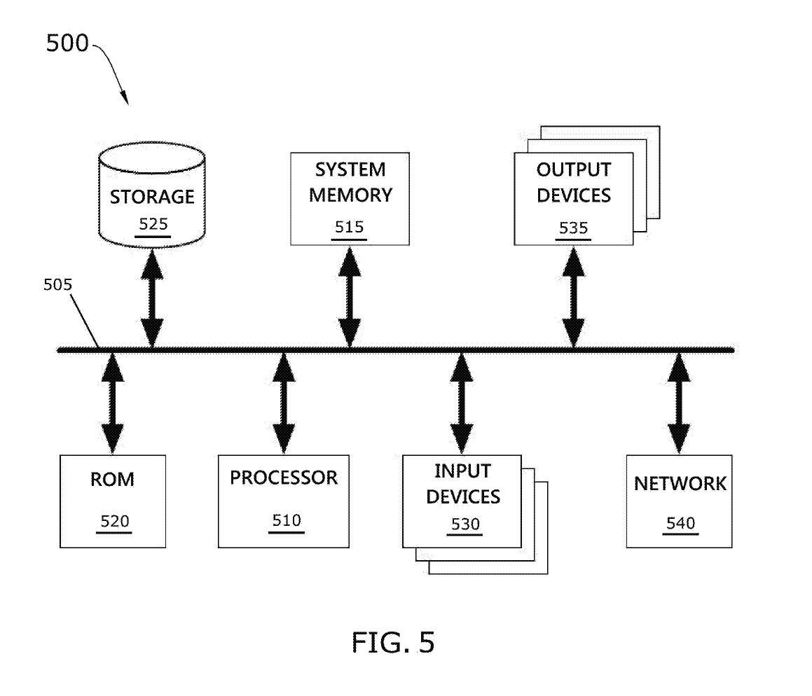

FIG. 5 conceptually illustrates an electronic system 500 with which some embodiments of the invention are implemented. The electronic system 500 may be a computer, phone (cell phone, mobile phone, smartphone, etc.), PDA (iPod, other handheld computing device, etc.), or any other sort of electronic device or computing device. Such an electronic system includes various types of computer readable media and interfaces for various other types of computer readable media. Electronic system 500 includes a bus 505, processing unit(s) 510, a system memory 515, a read-only 520, a permanent storage device 525, input devices 530, output devices 535, and a network 540.

The bus 505 collectively represents all system, peripheral, and chipset buses that communicatively connect the numerous internal devices of the electronic system 500. For instance, the bus 505 communicatively connects the processing unit(s) 510 with the read-only 520, the system memory 515, and the permanent storage device 525.

From these various memory units, the processing unit(s) 510 retrieves instructions to execute and data to process in order to execute the processes of the invention. The processing unit(s) may be a single processor or a multi-core processor in different embodiments.

The read-only-memory (ROM) 520 stores static data and instructions that are needed by the processing unit(s) 510 and other modules of the electronic system. The permanent storage device 525, on the other hand, is a read-and-write memory device. This device is a non-volatile memory unit that stores instructions and data even when the electronic system 500 is off. Some embodiments of the invention use a mass-storage device (such as a magnetic or optical disk and its corresponding disk drive) as the permanent storage device 525.

Other embodiments use a removable storage device (such as a floppy disk or a flash drive) as the permanent storage device 525. Like the permanent storage device 525, the system memory 515 is a read-and-write memory device. However, unlike storage device 525, the system memory 515 is a volatile read-and-write memory, such as a random access memory. The system memory 515 stores some of the instructions and data that the processor needs at runtime. In some embodiments, the invention's processes are stored in the system memory 515, the permanent storage device 525, and/or the read-only 520. For example, the various memory units include instructions for processing appearance alterations of displayable characters in accordance with some embodiments. From these various memory units, the processing unit(s) 510 retrieves instructions to execute and data to process in order to execute the processes of some embodiments.

The bus 505 also connects to the input and output devices 530 and 535. The input devices enable the user to communicate information and select commands to the electronic system. The input devices 530 include alphanumeric keyboards and pointing devices (also called “cursor control devices”). The output devices 535 display images generated by the electronic system 500. The output devices 535 include printers and display devices, such as cathode ray tubes (CRT) or liquid crystal displays (LCD). Some embodiments include devices such as a touchscreen that functions as both input and output devices.

Finally, as shown in FIG. 5, bus 505 also couples electronic system 500 to a network 540 through a network adapter (not shown). In this manner, the computer can be a part of a network of computers (such as a local area network (“LAN”), a wide area network (“WAN”), or an intranet), or a network of networks (such as the Internet). Any or all components of electronic system 500 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1 and 3-4 conceptually illustrate processes in which the specific operations of these processes may not be performed in the exact order shown and described. Specific operations may not be performed in one continuous series of operations, and different specific operations may be performed in different embodiments. Furthermore, the processes could be implemented using several sub-processes, or as part of a larger macro process. Thus, one of ordinary skill in the art would understand that the invention is not to be limited by the foregoing illustrative details, but rather is to be defined by the appended claims.

I claim:

1. A vital document and digital information management system that secures and releases personal information before and after a person's death, the vital document and digital information management system comprising:
a database for storing vital documents and digital information provided by a person using the vital document and digital information management system;
a web server computing device that hosts a website portal allowing the person to login to the vital document and digital information management system, select a set of menu options displayed on the website and associated with a set of website tools for uploading and storing vital documents and digital information, and perform a set of operations for providing vital documents and digital information to be stored in the vital document and digital information management system based on the selected menu options; and
a set of retrieval and distribution communication tools for accessing the vital documents and digital information of the person when the person passes away, said retrieval and distribution communication tools for retrieving a list of names of persons to contact upon the death of the person and for distributing the vital documents and digital information to the people whose names are listed.
